(19) United States
(12) Patent Application Publication
(10) Pub. No.: US 2004/0242759 A1
(43) Pub. Date: Dec. 2, 2004

(54) Bottom anti-reflective coating compositions comprising silicon containing polymers to improve adhesion towards photoresists

(76) Inventor: Mandar R. Bhave, Rolla, MO (US)

Correspondence Address: Hovey Williams LLP, Suite 400, 2405 Grand Blvd, Kansas City, MO, 64108, US

(21) Appl. No.: 10/449,589

(22) Filed: May 30, 2003

(51) Int. Cl. G03C 5/00

(52) U.S. Cl. 524/556; 524/558; 430/950; 430/325; 430/327; 430/312

(57) ABSTRACT

New anti-reflective compositions for use in 193 nm applications are provided. The compositions comprise a polymer having recurring silane monomers. The inventive compositions can be applied to substrates (e.g., silicon wafers) to form anti-reflective coating layers having improved adhesion of photoresists to the anti-reflective coating layer, thereby reducing or preventing the occurrence of photoresist pattern collapse typically seen in feature sizes of 100 nm or smaller.

### BACKGROUND OF THE INVENTION

1. Field of the Invention

The present invention is concerned with novel anti-reflective compositions and methods of using these new anti-reflective compositions to manufacture microelectronic devices. The compositions have improved adhesion characteristics and are useful in 193 nm applications.

2. Description of the Prior Art

The need for constant reduction in critical dimensions (CD) of integrated circuits has been the driving force for next generation lithography. If the semiconductor industry continues at its historical pace of packing more information on a chip, lithography using shorter wavelength (193 nm) will need to be introduced in production. As a result, integrated circuit manufacturers and equipment vendors are currently in the process of qualifying materials and processes for this type of technology.

Lithography using 193 nm wavelengths faces numerous challenges, including the problem of photoresist pattern collapse at sub-90 nm feature sizes. Several material and process solutions have been proposed to suppress the collapse of patterns including adding surfactants to photoresist developers and post-develop rinse liquids (like de-ionized water) to reduce surface tension and therefore reduce the capillary forces acting on the resist feature, freeze drying after the develop and rinse steps, adding modulus-enhancing materials to 193 nm photoresist compositions, and reducing the resist thickness. However, these methods assist in reducing collapse but do not completely prevent it. Furthermore, reducing the resist thickness results in very little resist being available after the bottom anti-reflective coating open etch process which is undesirable.

Hexamethyl disilazane (HMDS) is a commonly used adhesion promoting layer in the semiconductor industry. Typically, an HMDS vapor is generated and then deposited on bare silicon or other substrate to form a continuous film. Bottom anti-reflective coatings are widely used as underlayers for the photoresist in order to eliminate problems associated with reflective substrates like silicon, polysilicon, etc., and planarize topography in order to achieve tighter CD control. Bottom anti-reflective coatings have somewhat eliminated the use of HMDS since bottom anti-reflective coating layers can also act as adhesion layers besides primarily acting as anti-reflective layers.

The silicon surface is a high energy, hydrophilic surface, and conventional photoresists have difficulties adhering to silicon. As demonstrated in Scheme A, HMDS reacts with the moisture present on the surface to form covalent bonds (Si—O—Si). However, even with the HMDS layer, it has still been necessary to coat the silicon substrate with a bottom anti-reflective coating layer to reduce problems associated with reflective substrates.

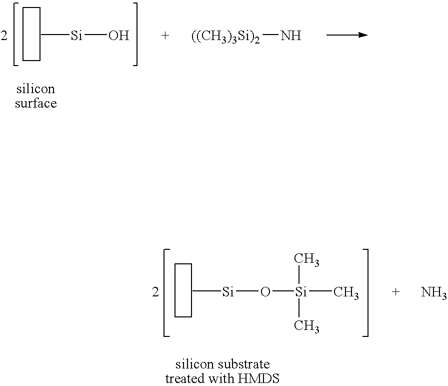

Thus, there is a need for anti-reflective coating compositions having improved adhesion between the photoresist and the anti-reflective coating film so that collapse of the photoresist patterns is substantially reduced and more preferably prevented.

### SUMMARY OF THE INVENTION

The present invention overcomes the problems of the prior art by broadly providing new anti-reflective coating compositions which have improved adhesion to photoresists. The compositions comprise polymers which include pendant silicon atoms in the polymer side chains, thus improving adhesion of photoresists to the bottom anti-reflective coating film and preventing collapse of photoresist patterns.

In more detail, the inventive compositions comprise a polymer dispersed in a solvent system. The polymer comprises recurring monomers having the formula

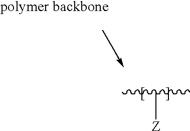

where Z has the formula

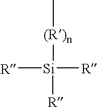

wherein:

each R′ is individually selected from the group consisting of alkyls (preferably C₁-C₈, and more preferably C₁-C₃), alkoxys (preferably C₁-C₈, and more preferably C₁-C₃), esters, and ethers;

n is 0-4; and

each R″ is individually selected from the group consisting of alkyls (preferably C₁-C₈, and more preferably C₁-C₃), alkoxys (preferably C₁-C₈, and more preferably C₁-C₃), halogens, substituted and unsubstituted phenyl groups, and —OSi(R′″)ₘ, where:

m is 1-3; and

each R′″ is individually selected from the group consisting of alkyls (preferably C₁-C₈, and more preferably C₁-C₃) and alkoxys (preferably C₁-C₈, and more preferably C₁-C₃).

Particularly preferred R′ groups include —CH₂CH₂CH₂—, —CH₂—, and —CH₂CH₂O—. Particularly preferred R″ groups include —OCH₃, —CH₃, —OCH₂CH₃, —CH₂CH₃, —Cl, —OSiOCH₃, —OSi(CH₃)₃, —OSiCH₂CH₃, and —OSiOCH₂CH₃.

In another embodiment, the polymer includes light attenuating compounds (i.e., dyes or chromophores) bonded thereto, with the light attenuating compounds including at least one Si atom.

In one embodiment, preferred recurring monomers have the formula

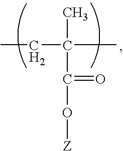

where Z is as described above. Preferred examples of monomers having this formula are

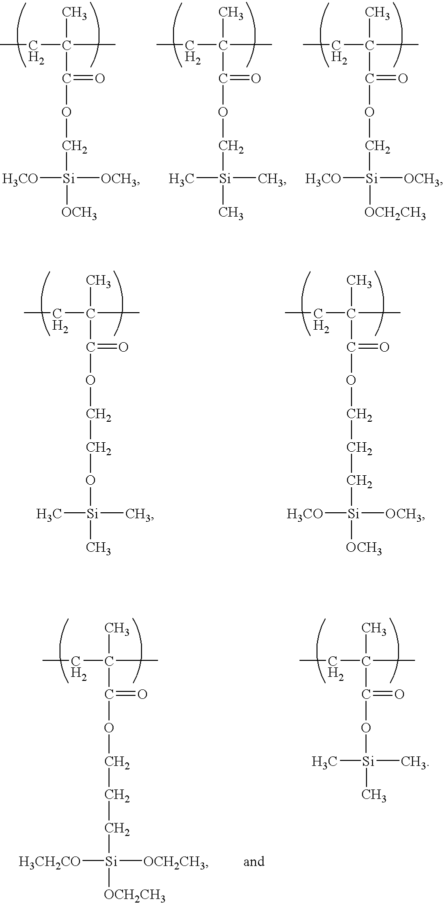

Regardless which of the foregoing monomers is utilized, it should be present in the polymer at a level of from about 5-50% by weight, and preferably from about 5-20% by weight, based upon the total weight of the polymer taken as 100% by weight.

Finally, while [symbol] can include any polymer, preferred polymers are those selected from the group consisting of acrylic polymers (e.g., acrylates, methacrylates), vinyl polymers, and mixtures thereof. It is preferred that the polymer include crosslinkable hydroxy (—OH) groups, amine (—NH₂) groups, amide (—NHCO) groups, epoxy groups, and carboxylic (—COOH) groups.

It is also preferred that the average molecular weight of the polymer be from about 500-100,000 Daltons, and more preferably from about 5,000-50,000 Daltons. The polymers are commercially available, or they can be formed by polymerizing the desired monomers according to known polymerization techniques or grafting (i.e., chemically attaching) a compound comprising the desired groups to a polymer.

These polymers can then be utilized to make compositions (e.g., anti-reflective coatings) for use in microlithographic processes. The compositions are formed by simply dispersing or dissolving the polymer(s) in a suitable solvent system, preferably at ambient conditions and for a sufficient amount of time to form a substantially homogeneous dispersion. Preferred compositions comprise from about 0.5-20% by weight of the polymer solids, and preferably from about 1-5% by weight of the polymer solids, based upon the total weight of the composition taken as 100% by weight.

The solvent systems can include any solvent suitable for use in the microelectronic manufacturing environment. Preferred solvent systems include a solvent selected from the group consisting of propylene glycol monomethyl ether (PGME), propylene glycol monomethyl ether acetate (PGMEA), ethyl lactate, propylene glycol, n-propyl ether (PnP), cyclohexanone, γ-butyrolactone, and mixtures thereof. Preferably, the solvent system has a boiling point of from about 50-150° C.

Any additional ingredients are also preferably dispersed in the solvent system along with the polymer. Examples of suitable additional ingredients include crosslinking agents, catalysts, and surfactants. Preferred crosslinking agents include aminoplasts (e.g., POWDERLINK® 1174, Cymel® products), multifunctional epoxy resins (e.g., MY720, CY179MA, DENACOL), anhydrides, and mixtures thereof. The crosslinking agent should be present in the composition at a level of from about 0.2-2% by weight, and preferably from about 0.5-1.0% by weight, based upon the total weight of the composition taken as 100% by weight. Thus, the compositions of the invention should crosslink at a temperature of from about 100-250° C., and more preferably from about 100-180° C.

Examples of preferred catalysts include sulfonic acids (e.g., p-toluenesulfonic acid, styrene sulfonic acid), thermal acid generators (e.g., pyridinium tosylate), carboxylic acids (e.g., trichloroacetic acid, benzene tetracsarboxylic acid), and mixtures thereof. The catalyst should be present in the composition at a level of from about 0.01-0.10% by weight, and preferably from about 0.02-0.05% by weight, based upon the total weight of the composition taken as 100% by weight.

The method of applying the inventive anti-reflective compositions to a substrate (e.g., Si, Al, W, WSi, GaAs, SiGe, Ta, and TaN wafers) simply comprises applying a quantity of a composition hereof to the substrate surface (either a planar surface or one comprising vias or holes formed therein) by any conventional application method, including spin-coating. The layer should then be heated to at least about the crosslinking temperature of the composition (e.g., about 100-200° C.) so as to cure the layer having a thickness of anywhere from about 250-2000 Å where the thickness is defined as the average of 5 measurements taken by an ellipsometer. A photoresist can then be applied to the cured material, followed by exposing, developing, and etching the photoresist.

Anti-reflective coatings according to the invention have high etch rates. Thus, the cured anti-reflective coatings have an etch selectivity to resist (i.e., the anti-reflective coating layer etch rate divided by the photoresist etch rate) of at least about 0.8, and preferably from about 1.0-1.6 when HBr/O₂ (60/40) is used as the etchant and a 193 nm photoresist is used. Additionally, at about 193 nm a cured layer formed from the inventive composition and having a thickness of about 300 Å will have a k value (i.e., the imaginary component of the complex index of refraction) of at least about 0.2, and preferably at least about 0.6. Finally, the coatings can be used to obtain a dense line space resolution of about 90 nm with 193 nm photoresists.

### BRIEF DESCRIPTION OF THE DRAWINGS

FIG. 1 depicts a scanning electron microscope (SEM) photograph showing cross-sectional views of a prior art silicon wafer which has experienced photoresist collapse; and

FIG. 2 shows an SEM photograph depicting cross-sectional views of a silicon wafer coated with an anti-reflective coating composition according to the invention.

### DETAILED DESCRIPTION OF THE PREFERRED EMBODIMENTS

### EXAMPLES

The following example sets forth preferred methods in accordance with the invention. It is to be understood, however, that this example is provided by way of illustration and nothing therein should be taken as a limitation upon the overall scope of the invention.

1. Preparation of Polymer Mother Liquor

In this procedure, 15.0 g (85% by mol. wt.) of an acrylate monomer (2-hydroxy 3-phenoxy propyl acrylate; obtained from Toagesei Chemical Co., Japan), 2.95 g (15% by mol. wt.) of a silane functional methacrylate monomer (methacyloxy propyltrimethoxy silane; obtained from Gelest, Inc.), and 0.1795 g of an initiator (azodiisobutyronitrile; obtained from Aldrich Chemical Co.) were dissolved in 72.51 g of PGME. The monomer solution was approximately 20% by weight solids and was stirred at 70° C. for 24 hours.

2. Formulation of the Anti-Reflective Coating

An anti-reflective coating was formulated by mixing 10.0 g of the polymer mother liquor prepared in Part 1 of this example with 1.264 g of a crosslinker (POWDERLINK 1174®) and 0.051 g of a catalyst (p-toluenesulfonic acid) in 153.94 g of a 10:90 PGME:PGMEA solvent mixture.

3. Film Properties

The product was spincoated (2500 rpm/60 sec) onto silicon wafers followed by baking at 205° C. for 60 sec using a vacuum hotplate. Film thickness measurements were taken using an ellipsometer while the optical properties of the film were determined using a J. A. Woollam VASE™ (variable angle spectroscopic ellipsometer). The n value of the film was 1.74, and the k value was 0.52

4. Photolithography

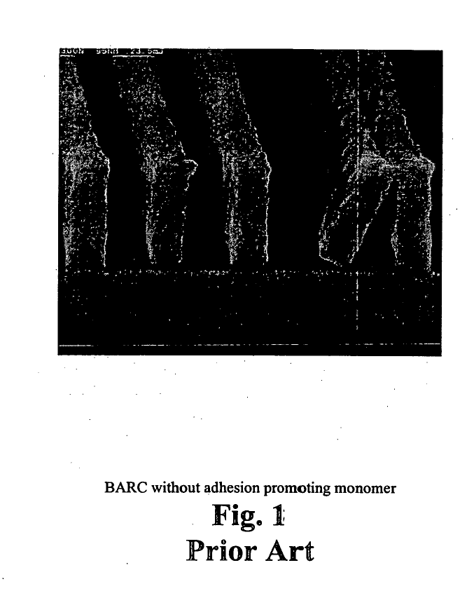

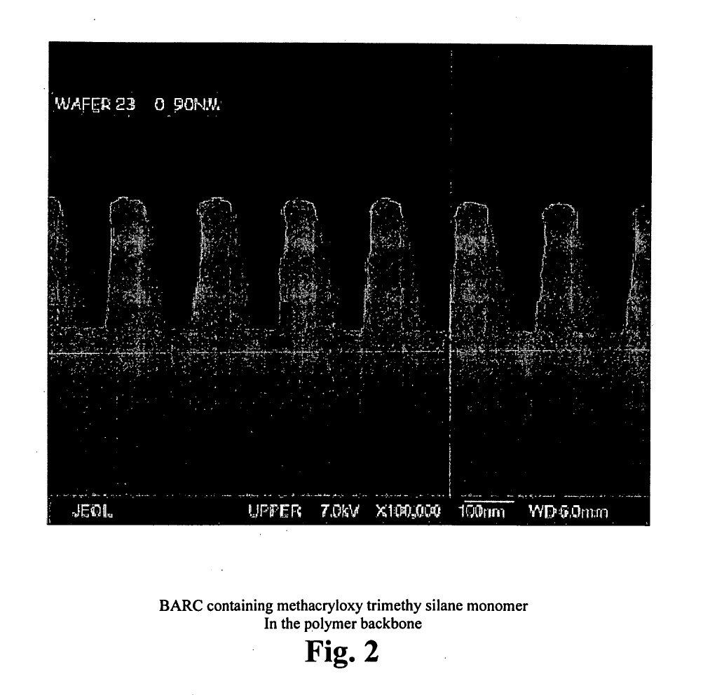

For comparison purposes, FIG. 1 shows the photoresist collapse experienced with prior art anti-reflective coating compositions. With the inventive composition of this example, photolithography was carried out using an ArF photoresist with a target critical dimension of 90 nanometers for lines and spaces. As shown in FIG. 2, the imaging performance was excellent, and all of the lines were standing with no collapse observed. This was due to the enhanced adhesion between the anti-reflective coating and the photoresist.

1. In an anti-reflective composition comprising a polymer dispersed in a solvent system, the improvement being that said polymer comprises recurring monomers having the formula 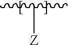
where Z has the formula 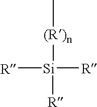
wherein:
each R′ is individually selected from the group consisting of alkyls, alkoxys, esters, and ethers;
n is 0-4; and
each R″ is individually selected from the group consisting of alkyls, alkoxys, halogens, substituted and unsubstituted phenyl groups, and —OSI(R′″)ₘ, where:
m is 1-3; and
each R′″ is individually selected from the group consisting of alkyls and alkoxys
said composition, when formed into a layer having a thickness of about 300 Å, having a k value of at least about 0.6 at a light wavelength of about 193 nm.

2. The composition of claim 1, wherein R′ is selected from the group consisting of —CH₂CH₂CH₂—, —CH₂—, and —CH₂CH₂O—.

3. The composition of claim 1, wherein each R″ is individually selected from the group consisting of —OCH₃, —CH₃, —OCH₂CH₃, —CH₂CH₃, —Cl, —OSiOCH₃, —OSi(CH₃)₃, —OSiCH₂CH₃, and —OSiOCH₂CH₃.

4. The composition of claim 1, wherein [symbol] is selected from the group consisting of acrylic polymers, vinyl polymers, and mixtures thereof.

5. The composition of claim 4, wherein said recurring monomers have the formula

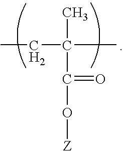

6. The composition of claim 5, wherein said recurring monomers have a formula selected from the group consisting of

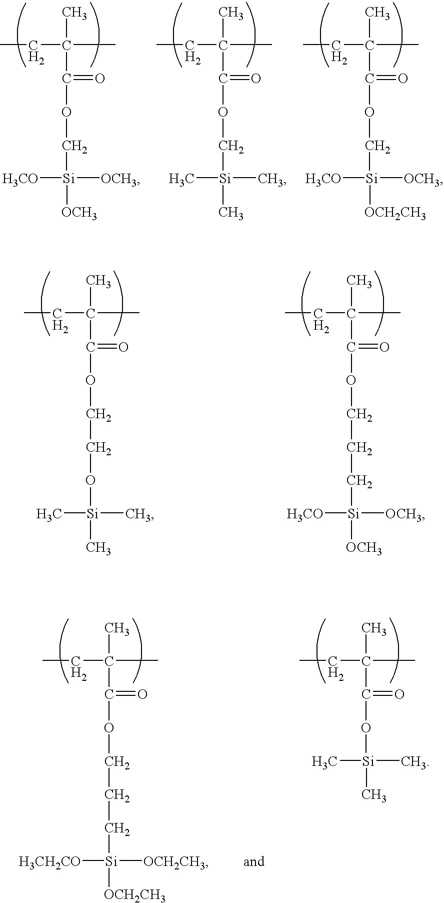

7. The composition of claim 1, wherein said polymer has an average molecular weight of from about 500-100,000 Daltons.

8. The composition of claim 1, wherein said recurring monomer is present in said polymer at a level of from about 5-50% by weight, based upon the total weight of the polymer taken as 100% by weight.

9. The composition of claim 1, wherein said composition further comprises a compound selected from the group consisting of crosslinking agents, catalysts, surfactants, and mixtures thereof.

10. The composition of claim 9, wherein said compound is a crosslinking agent selected from the group consisting of aminoplasts, epoxy resins, anhydrides, and mixtures thereof.

11. The composition of claim 9, wherein said compound is a catalyst selected from the group consisting of sulfonic acids, thermal acid generators, carboxylic acids, and mixtures thereof.

12. The composition of claim 1, wherein said solvent system includes a solvent selected from the group consisting of propylene glycol monomethyl ether, propylene glycol monomethyl ether acetate, ethyl lactate, propylene glycol, n-propyl ether, cyclohexanone, γ-butyrolactone, and mixtures thereof.

13. A cured anti-reflective layer formed from a composition comprising a polymer dissolved in a solvent system, said polymer including recurring monomers having the formula 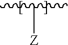
where Z has the formula 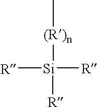
wherein:
each R′ is individually selected from the group consisting of alkyls, alkoxys, esters, and ethers;
n is 0-4; and
each R″ is individually selected from the group consisting of alkyls, alkoxys, halogens, substituted and unsubstituted phenyl groups, and —OSi(R′″)ₘ, where:
m is 1-3; and
each R′″ is individually selected from the group consisting of alkyls and alkoxys,
said cured layer having a k value of at least about 0.6 at a light wavelength of about 193 nm and at a thickness of about 300 Å.

14. The layer of claim 13, wherein R′ is selected from the group consisting of —CH₂CH₂CH₂—, —CH₂—, and —CH₂CH₂O—.

15. The layer of claim 13, wherein each R″ is individually selected from the group consisting of —OCH₃, —CH₃, —OCH₂CH₃, —CH₂CH₃, —Cl, —OSiOCH₃, —OSi(CH₃)₃, —OSiCH₂CH₃, and —OSiOCH₂CH₃.

16. The layer of claim 13, wherein [symbol] is selected from the group consisting of acrylic polymers, vinyl polymers, and mixtures thereof.

17. The layer of claim 13, wherein said recurring monomers have the formula

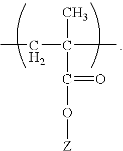

18. The layer of claim 17, wherein said recurring monomers have a formula selected from the group consisting of

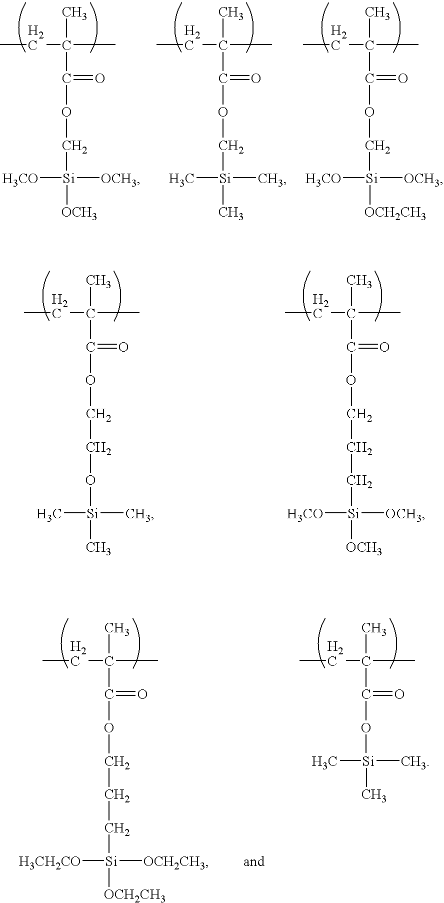

19. The layer of claim 13, wherein said polymer has an average molecular weight of from about 500-100,000 Daltons.

20. The layer of claim 13, wherein said recurring monomer is present in said polymer at a level of from about 5-50% by weight, based upon the total weight of the polymer taken as 100% by weight.

21. The layer of claim 13, wherein said composition further comprises a compound selected from the group consisting of crosslinking agents, catalysts, surfactants, and mixtures thereof.

22. The layer of claim 21, wherein said compound is a crosslinking agent selected from the group consisting of aminoplasts, epoxy resins, anhydrides, and mixtures thereof.

23. The layer of claim 21, wherein said compound is a catalyst selected from the group consisting of sulfonic acids, thermal acid generators, carboxylic acids, and mixtures thereof.

24. The layer of claim 13, wherein said solvent system includes a solvent selected from the group consisting of propylene glycol monomethyl ether, propylene glycol monomethyl ether acetate, ethyl lactate, propylene glycol, n-propyl ether, cyclohexanone, γ-butyrolactone, and mixtures thereof.

25. The layer of claim 13, wherein said layer is adjacent a substrate.

26. The layer of claim 25, wherein said substrate is selected from the group consisting of Si, Al, W, WSi, GaAs, SiGe, Ta, and TaN wafers.

27. A method of using an anti-reflective composition, said method comprising the steps of:
applying a quantity of the composition to a substrate to form a layer thereon, said composition comprising a polymer dispersed in a solvent system, the improvement being that said polymer comprises recurring monomers having the formula 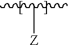
where Z has the formula 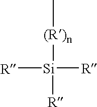
wherein:
each R′ is individually selected from the group consisting of alkyls, alkoxys, esters, and ethers;
n is 0-4; and
each R″ is individually selected from the group consisting of alkyls, alkoxys, halogens, substituted and unsubstituted phenyl groups, and —OSi(R′″)ₘ, where:
m is 1-3; and
each R′″ is individually selected from the group consisting of alkyls and alkoxys; and
curing said layer, said cured layer having a k value of at least about 0.6 at a light wavelength of about 193 nm and at a thickness of about 300 Å.

28. The method of claim 27, wherein said applying step comprises spin-coating said composition onto said substrate surface.

29. The method of claim 27, wherein said substrate has a hole formed therein, said hole being defined by a bottom wall and sidewalls, and said applying step comprises applying said composition to at least a portion of said bottom wall and sidewalls.

30. The method of claim 27, wherein said curing step comprises baking said layer at a temperature of from about 100-200° C. to yield the cured layer.

31. The method of claim 30, further including the step of applying a photoresist to said baked layer.

32. The method of claim 31, furthering including the steps of:
exposing at least a portion of said photoresist to activating radiation;
developing said exposed photoresist; and
etching said developed photoresist.

33. The method of claim 27, wherein R′ is selected from the group consisting of —CH₂CH₂CH₂—, —CH₂—, and —CH₂CH₂O—.

34. The method of claim 27, wherein each R″ is individually selected from the group consisting of —OCH₃, —CH₃, —OCH₂CH₃, —CH₂CH₃, —Cl, —OSiOCH₃, —OSi(CH₃)₃, —OSiCH₂CH₃, and —OSiOCH₂CH₃.

35. The method of claim 27, wherein [symbol] is selected from the group consisting of acrylic polymers, vinyl polymers, and mixtures thereof.

36. The method of claim 27, wherein said recurring monomers have the formula

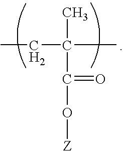

37. The method of claim 36, wherein said recurring monomers have a formula selected from the group consisting of

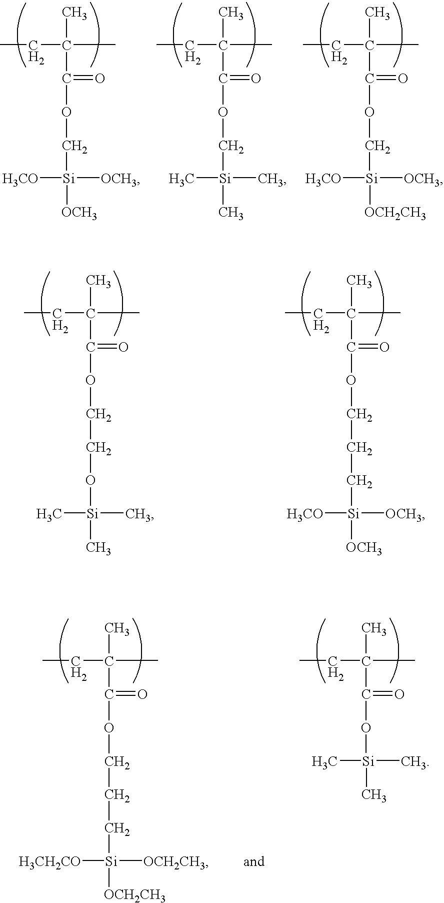

38. The method of claim 27, wherein said polymer has an average molecular weight of from about 500-100,000 Daltons.

39. The method of claim 27, wherein said recurring monomer is present in said polymer at a level of from about 5-50% by weight, based upon the total weight of the polymer taken as 100% by weight.

40. The method of claim 27, wherein said composition further comprises a compound selected from the group consisting of crosslinking agents, catalysts, and mixtures thereof.

41. The method of claim 40, wherein said compound is a crosslinking agent selected from the group consisting of aminoplasts, epoxy resins, anhydrides, and mixtures thereof.

42. The method of claim 40, wherein said compound is a catalyst selected from the group consisting of sulfonic acids, thermal acid generators, carboxylic acids, and mixtures thereof.

43. The method of claim 27, wherein said solvent system includes a solvent selected from the group consisting of propylene glycol monomethyl ether, propylene glycol monomethyl ether acetate, ethyl lactate, propylene glycol, n-propyl ether, cyclohexanone, γ-butyrolactone, and mixtures thereof.

44. In an anti-reflective composition comprising a polymer dispersed in a solvent system, the improvement being that said polymer comprises recurring monomers having the formula 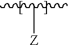
where Z has the formula 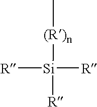
wherein:
each R′ is individually selected from the group consisting of alkyls, alkoxys, esters, and ethers;
n is 0-4; and
each R″ is individually selected from the group consisting of alkoxys and halogens.

45. The combination of:
an anti-reflective layer formed from a composition comprising a polymer dissolved in a solvent system, said polymer including recurring monomers having the formula 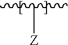
where Z has the formula 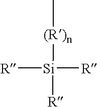
wherein:
each R′ is individually selected from the group consisting of alkyls, alkoxys, esters, and ethers;
n is 0-4; and
each R″ is individually selected from the group consisting of alkyls, alkoxys, halogens, substituted and unsubstituted phenyl groups, and —OSi(R′″)ₘ, where:
m is 1-3; and
each R′″ is individually selected from the group consisting of alkyls and alkoxys; and
a photoresist layer adjacent said anti-reflective layer.

46. A method of using an anti-reflective composition, said method comprising the steps of:
applying a quantity of the anti-reflective composition to a substrate to form a layer thereon, said composition comprising a polymer dispersed in a solvent system, said polymer comprises recurring monomers having the formula 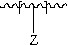
where Z has the formula 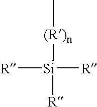
wherein:
each R′ is individually selected from the group consisting of alkyls, alkoxys, esters, and ethers;
n is 0-4; and
each R″ is individually selected from the group consisting of alkyls, alkoxys, halogens, substituted and unsubstituted phenyl groups, and —OSi(R′″)ₘ, where:
m is 1-3; and
each R′″ is individually selected from the group consisting of alkyls and alkoxys; and
applying a photoresist layer to said anti-reflective composition layer.
